(19) United States
(12) Patent Application Publication
(10) Pub. No.: US 2017/0159699 A1
(43) Pub. Date: Jun. 8, 2017

(54) FLEX SHAFT

(71) Applicant: Matt Barnes, The Woodlands, TX (US)

(72) Inventor: Matt Barnes, The Woodlands, TX (US)

(73) Assignee: Multi-Shot, LLC, Conroe, TX (US)

(21) Appl. No.: 15/368,858

(22) Filed: Dec. 5, 2016

Related U.S. Application Data
(60) Provisional application No. 62/263,273, filed on Dec. 4, 2015.

(51) Int. Cl. F16C 1/02; E21B 17/20

(52) U.S. Cl. CPC F16C 1/02; E21B 17/20

(57) ABSTRACT

A flex shaft for a motor may comprise a hollow tubular member with first and second connector ends. In some embodiments, a thickness or wall thickness of the tubular member may be selected in accordance with a desired strength or torque the flex shaft must be capable of handling. In some embodiments, a plurality of openings may be provided in the wall of the tubular member to provide a desired level of flexibility. The plurality of openings may be arranged or patterned in numerous ways discussed herein. The flex shaft allows a shorter overall length to be used than for a conventional solid shaft.

### RELATED APPLICATIONS

This application claims the benefit of U.S. Provisional Patent Application No. 62/263,273 filed on Dec. 4, 2015, which is incorporated herein by reference.

### FIELD OF THE INVENTION

This invention relates to flex shafts. More particularly, to flex shafts for downhole motors.

### BACKGROUND OF INVENTION

A drive shaft may be utilized to couple two components of a motor together to allow rotational motion to be transmitted. In some cases, it may be desirable to provide a flexible drive shaft or flex shaft when a portion the motor may be subjected to bending stresses during operation. An example of a flexible drive shaft is provided in U.S. Pat. No. 5,135,059. One of the difficulty with flexible drive shafts is that the diameter of the drive shaft may be selected in accordance with a desired strength, whereas the length is selected in accordance with a desired flexibility. However, in some cases, the resulting drive shaft may be too long or impractical. An improved flex shaft for a downhole motor is discussed further herein.

### SUMMARY OF INVENTION

In one embodiment, a flex shaft for a motor may comprise a hollow tubular member with first and second connector ends. In some embodiments, a thickness or wall thickness of the tubular member may be selected in accordance with a desired strength or torque the flex shaft must be capable of handling. In some embodiments, a plurality of openings may be provided in the wall of the tubular member to provide a desired level of flexibility. The plurality of openings may be arranged or patterned in numerous ways. As nonlimiting examples, the openings may be arranged or patterned in sets of openings, in a manner parallel to a central axis, selected from a variety of shapes, spaced apart equally, angularly spaced apart equally, offset relative to latitude, sized to span a certain circumference, in a spiral pattern, or any suitable combination thereof. The flex shaft allows a shorter overall length to be used than for a conventional solid shaft.

The foregoing has outlined rather broadly various features of the present disclosure in order that the detailed description that follows may be better understood. Additional features and advantages of the disclosure will be described hereinafter.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIGS. 1A-1C are illustrative embodiments of a flex shaft; and

FIGS. 2A-2C show detail views of illustrative embodiments of a flex shaft.

### DETAILED DESCRIPTION

Refer now to the drawings wherein depicted elements are not necessarily shown to scale and wherein like or similar elements are designated by the same reference numeral through the several views.

Referring to the drawings in general, it will be understood that the illustrations are for the purpose of describing particular implementations of the disclosure and are not intended to be limiting thereto. While most of the terms used herein will be recognizable to those of ordinary skill in the art, it should be understood that when not explicitly defined, terms should be interpreted as adopting a meaning presently accepted by those of ordinary skill in the art.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

A flex shaft may couple a driven component of a motor to another component of the motor to transfer rotational motion. As a nonlimiting example, a flex shaft may couple a rotor to a bearing mandrel of a downhole motor. In some embodiments, the rotor may be positioned off center (eccentric) with respect to the mandrel. The drive coupling or flex shaft may transfer eccentric rotary motion of the rotor to the on center bearing mandrel.

Existing drive shafts are solid in diameter. The drive shaft may be selected to be large enough in diameter to handle the necessary torque, but flexible enough to accommodate the eccentric offset. Additionally, the drive shaft diameter may be selected for desired strength, and lengthened to account for desired flex. However, this may result in a shaft that is too long for practical application.

In some embodiments, a flex shaft may be formed from a hollow, cylindrical member, such as a pipe, tube, shaft, or tubular. The tube may be sized, or the inner and outer diameter (ID and OD respectively) chosen, according to a desired torque it may handle. Each end of the tube may provide any suitable connection mechanism or connector ends. Between the connector ends, a plurality of openings may be provided through the tube wall. The plurality of openings may be arranged or patterned in numerous ways. As nonlimiting examples, the openings may be arranged or patterned in sets of openings, in a manner parallel to a central axis, selected from a variety of shapes, spaced apart equally, angularly spaced apart equally, offset relative to latitude, sized to span a certain circumference, in a spiral pattern, or any suitable combination thereof.

In some embodiments, the plurality of openings may arranged to span any desirable distance between the connector ends. In some embodiments, the openings maybe formed in any suitable shape, such as circular, ovular, square, rectangular, the like, or a combination thereof. The opening size, number of openings, shape of openings, or a combination thereof may be selected to provide a desired level of flexibility.

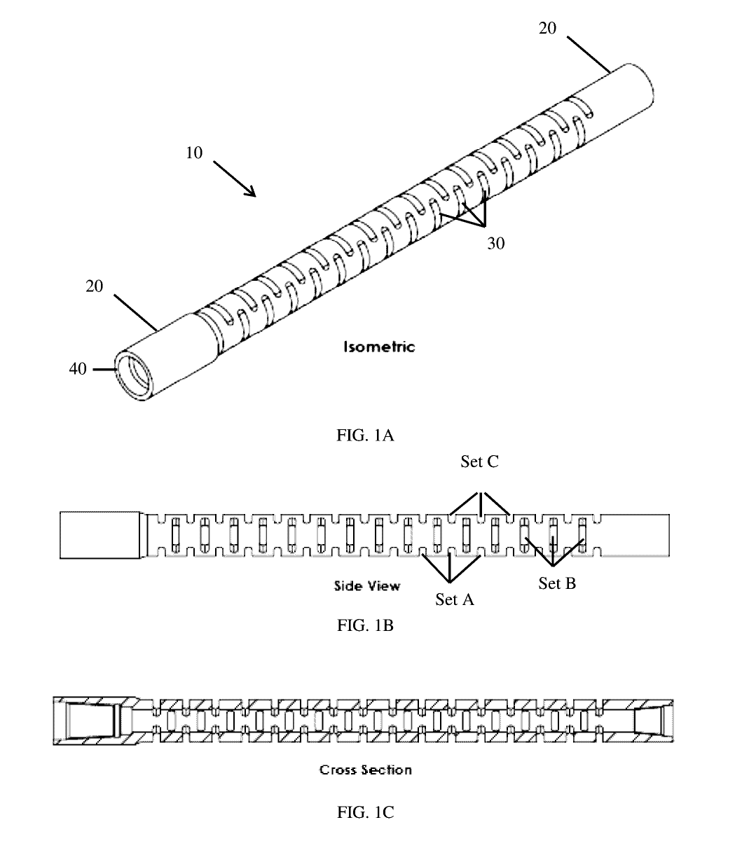

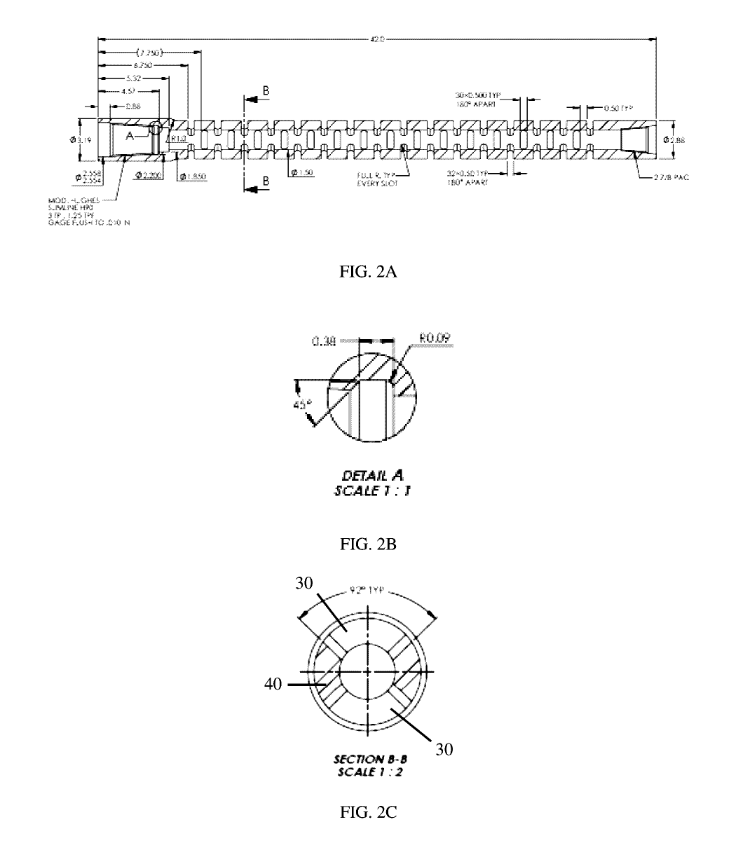

FIGS. 1A-1C respectively show isometric, side, and cross section views of an illustrative example of a flex shaft 10. Connector ends 20 of a generally tubular flex shaft 10 are utilized to couple components of a mud motor together (e.g. rotor to bearing mandrel). Between connector ends, several openings 30 may be provided in the tube wall 40 to provide a desired level of flexibility. FIGS. 2A-2C show a detailed cross-section view, close up view of detail A, and close up view of section B-B.

In some embodiments, the size, number, shape, and arrangement of the openings may be adjusted to achieve a desired level of flexibility. It should be noted that following discussions of the arrangement of the openings provided herein are generally directed to an arrangement relative to the center of the openings. Further, the openings are generally assumed to be uniform in shape for simplicity in determining an acceptable arrangement. However, it shall be apparent to one of ordinary skill in the art un-uniform openings are also acceptable. In some embodiments, the openings 30 may be arranged into one or more sets running the length of the shaft 10. Further, each of the openings 30 in the set may be optionally spaced apart by a set distance. In other embodiments, the set distance spacing between openings may vary from each opening in the set. As a nonlimiting example in FIG. 1A, four sets of openings 30 in sets of 15 or 16 opening may run in parallel along the length of the shaft to provide a total of 62 openings. In other words, a line drawn though the center of one the openings 30 is parallel to the central axis of the shaft 10. While the example shown provides sets with an unequal number of openings, other embodiments may utilize sets with an equal number of openings. As shown in FIG. 1B, Set A, Set B, and Set C of the openings 30 run the length of shaft 10 (the fourth Set D is not shown, but is present on the back portion of the shaft that cannot be seen from the view provided in FIG. 1B). The sets of openings 30 may be angularly spaced, relative to an axis running through the center of the shaft (e.g. view shown in FIG. 2C), from each by a predetermined amount. In some embodiments, the sets of openings may be angularly spaced in an equidistant manner. As shown in the nonlimiting examples, the centers of the opening for the four sets of opening are spaced 90° apart. Further, it shall be apparent to one of ordinary skill that in other embodiments, the desired equidistant angular spacing can be determined by dividing 360 degrees by the number of opening sets present. In other embodiments, non-equidistant angular spacing is possible, but requires consideration of the other opening arrangement parameters to avoid the intersection or overlapping of openings.

In some embodiments, the arrangement of the openings 30 of adjacent sets may be offset relative to a latitude of the shaft 10. In other words, adjacent set of openings 30 (e.g. Sets A & B or Sets B & C) may avoid positioning openings along a common longitudinal plane relative to the central axis of shaft 10. Further, the offset may factor in the size and shape of the openings as well. This may allow wider openings 10 to be provided without overlapping. As the nonlimiting example in FIG. 2C shows, from a view from the central axis of the tubular, the openings may span equal to or greater than 90° of the circumference of the shaft 10 and less than 180° of the circumference of the shaft. However, in other embodiments with fewer than four sets of openings, the openings may span a larger range. In embodiments, with more than four sets of openings, the openings may require a smaller range spanning the circumference. Generally, the acceptable circumference of the shaft 10 that the openings 30 may span corresponds to the number of opening present along a common longitudinal plane relative to the central axis of shaft 10, as well as the minimum separation desired between the openings or maximum circumference any one opening may span. For example, when no openings share a common longitudinal plane, the openings can theoretically span nearly 360°, although the maximum circumference that any one opening spans may be significantly lower to avoid the risk of the shaft being damaged. As another example, when three openings are present along a common longitudinal plane, the openings must span less 120° to avoid intersection.

As another nonlimiting example, the openings may be arranged into one or more sets, where each set is arranged in a spiral or pitch pattern around the shaft (not shown). For example, in contrast to the abovenoted arrangements where the sets of openings are arranged parallel to a central axis of the shaft, a set of openings in such an arrangement may be visualized as being arranged along a line in a helix pattern around the central axis of the shaft, either clockwise or counterclockwise. It shall be apparent to one of ordinary skill in the art that the number of opening along the spiral influences the flexibility of the shaft. Similarly, as noted previously, the size, number, shape, spacing between opening, angular spacing between sets of openings, latitude offset, the circumference of the shaft the openings span, and arrangement of the openings may be adjusted to achieve a desired level of flexibility.

In some embodiments, methods for forming a flex shaft may utilize a variety of known methods for manufacturing metal pipes or for processing metal in desired shapes. Various methods are known in the art for forming metal pipes. As nonlimiting examples, seamless pipes may be formed piercing or extrusion, and welded pipes may be formed by rolling (e.g. butt welded or ERW), pressing (e.g. UO pipe), or spiral rolling (e.g. spiral pipe) and welding. Other nonlimiting examples for metal pipes may involve casting. However, traditional pipes do not involve subsequent processing to form a plurality of openings in the wall of the pipe. In some embodiments, any of the plurality of opening setups discussed above may be formed by machining, stamping, piercing, cutting, or the like. In some embodiments involving casting, the mold for casting may include the desired plurality of openings to reduce the processing necessary. In embodiments involving cutting, the plurality of openings may be formed utilizing any suitable cutting methods, including, but not limited to, laser, plasma, water jet, cutting torch, or the like. In some embodiments, the flex shaft may be formed from a non-metal or composite material. Further, any methods that are suitable the non-metal or composite materials may be utilized to form such flex shafts.

Embodiments described herein are included to demonstrate particular aspects of the present disclosure. It should be appreciated by those of skill in the art that the embodiments described herein merely represent exemplary embodiments of the disclosure. Those of ordinary skill in the art should, in light of the present disclosure, appreciate that many changes can be made in the specific embodiments described and still obtain a like or similar result without departing from the spirit and scope of the present disclosure. From the foregoing description, one of ordinary skill in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure.

What is claimed is:

1. A flexible shaft comprising:
a hollow tubular, wherein the hollow tubular provides a first connector end and a second connector end; and
a plurality of openings in a wall of the hollow tubular, wherein the plurality of openings span a distance between the first and the second connector ends.

2. The shaft of claim 1, wherein the plurality of openings are circular, ovular, square, rectangular, or a combination thereof.

3. The shaft of claim 1, wherein the plurality of openings are arranged into one or more sets running along the length of the hollow tubular.

4. The shaft of claim 3, wherein the plurality of openings in each set are spaced apart by a set distance.

5. The shaft of claim 3, wherein the one or more sets are angularly spaced apart from each other relative to an axis through a center of the hollow tubular.

6. The shaft of claim 5, wherein the one or more sets are angularly spaced apart from each other with equidistant angular spacing.

7. The shaft of claim 6, wherein the plurality of openings in each set are spaced apart by a set distance.

8. The shaft of claim 6, wherein the one or more sets are angularly spaced apart by 90°.

9. The shaft of claim 6, wherein the openings of adjacent sets of the one or more sets are offset relative to a latitude of the hollow tubular.

10. The shaft of claim 6, wherein the openings span ≧90° of a circumference of the hollow tubular and ≦180° of the circumference of the hollow tubular.

11. The shaft of claim 10, wherein the openings of adjacent sets of the one or more sets are offset relative to a latitude of the hollow tubular.

12. The shaft of claim 3, wherein the sets are arranged in a spiral pattern.

13. The shaft of claim 1, wherein the first connector end attaches to a rotor of a motor.

14. The shaft of claim 1, wherein the second connector end attaches to a bearing mandrel.

15. A method for forming a flexible shaft, the method comprising:
forming a hollow tubular, wherein the hollow tubular provides a first connector end and a second connector end; and
forming a plurality of openings in a wall of the hollow tubular, wherein the plurality of openings span a distance between the first and the second connector ends.

16. The method of claim 15, wherein the plurality of openings are arranged into one or more sets running along the length of the hollow tubular.

17. The method of claim 15, wherein the one or more sets are angularly spaced apart from each other relative to an axis through a center of the hollow tubular, and the openings of adjacent sets of the one or more sets are offset relative to a latitude of the hollow tubular.

18. The method of claim 16, wherein openings in each set are spaced apart by a set distance, and the one or more sets are angularly spaced apart with an equidistant angular spacing.

19. The method of claim 16, wherein the one or more sets are angularly spaced apart by 90°, and the openings span ≧90° of a circumference of the hollow tubular and ≦180° of the circumference of the hollow tubular.

20. The method of claim 15, wherein the sets are arranged in a spiral pattern.
